(19) United States
(12) Patent Application Publication
(10) Pub. No.: US 2024/0249232 A1
(43) Pub. Date: Jul. 25, 2024

(54) REMOTE MACHINE ACCESS, MONITORING AND REPORTING SYSTEM

(71) Applicant: Gençler Elektronik San. Ve Tic. Ltd. Sti., Basaksehir/Istanbul (TR)

(72) Inventor: Hakan Eksi, Basaksehir/Istanbul (TR)

(73) Assignee: Gençler Elektronik San. Ve Tic. Ltd. Sti., Basaksehir/Istanbul (TR)

(21) Appl. No.: 18/561,668

(22) PCT Filed: Jun. 23, 2021
(86) PCT No.: PCT/TR2021/050642

§ 371 Date: Nov. 16, 2023

(30) Foreign Application Priority Data
May 21, 2021 (TR) 2021/008476

(51) Int. Cl. G06Q 10/0639

(52) U.S. Cl. CPC G06Q 10/0639

(57) ABSTRACT

The invention relates to a system and method allowing remote access, monitoring, and reporting, wherein the said system and method enables the monitoring of machines connected to the system via an internet connection, the calculating of instant costs per production/work order, and the daily, weekly, or monthly monitoring and reporting of the concerned machine's efficiency based on these operation and cost parameters, in addition to enabling the performing of general updates through remote intervention in case of any malfunction in the machine.

### TECHNICAL FIELD

The invention relates to a system and method allowing remote access, monitoring, and reporting, wherein the said system and method enables the monitoring of machines connected to the system via an internet connection, the calculating of instant costs per production/work order, and the daily, weekly, or monthly monitoring and reporting of the concerned machine's efficiency based on these operation and cost parameters, in addition to enabling the performing of general updates through remote intervention in case of any malfunction in the machine.

### BACKGROUND ART

Machines that enable obtaining continuous (uninterrupted) plastic products with the same cross-sectional profile, precise dimensions, and desired length, are called extrusion machines. They are called extruders in short. Extrusion, which is one of the most widely used methods in processing plastics, includes the use of a screw in a cylinder. The plastic is fed into the screw through a hopper, usually in powder or granular form. Screw and barrel are the units that are effective in delivering and melting the plastic material and creating pressure thereon. The gear system rotates the screw at a controlled speed. The barrel is equipped with heating and cooling equipment connected to temperature controllers. The molten blend is continuously fed into the extruder through the hopper. The mixture, which arrives at the heating cylinder first, is pushed by the screw, and as it moves towards the output point, it warms up and softens. Heating can be achieved externally with electric heaters or induction on the cylinder wall, as well as through internal friction. Friction heat is benefitted significantly within the scope of these systems. Melting is controlled by two heat sources. The first is usually the barrel heater (mica and ceramic resistances) applying heat externally. The second source of heat is called shear or viscous heating. Heating can be controlled by changing the rotational speed of the screw. Choosing the most suitable rotational speed is of great importance. At a low speed, the molten mixture stays in contact with the barrel and screw for a longer period of time. Since low speed will reduce shear, thereby decreasing the amount of dissipative heat, the film properties of this composition are strengthened. For optimum screw design, the trial and error method and computer modeling method should be used together.

There are a wide variety of extruders in the market, produced according to needs. In addition to these, there are dosing devices utilized to mix a certain amount of minor ingredients (dye, regrind raw material, etc.) into the main raw material. For example, if concentrated dye at a rate of 1.6% is wished to be mixed into 100 kg of original raw material, the dosing device is the go-to device to do this.

Dosing devices have distinct operating principles. Typically, single- and multiple-material dosing devices are commonly used. In single-material dosing devices, the main ingredient is introduced to the plastic processing machine by freely flowing through the throat while the additive is blended into the main ingredient at the desired rate with the help of a dosing screw. Multiple-material dosing devices may employ the same principle; there are also batch dosing devices that dose more than two materials. Batch dosing devices weigh and mix the main ingredient and other additives individually.

In the current art, there are significant ongoing studies on the software of these devices in order to maximize production and efficiency. The proliferation of machines undertaking different duties in the production line necessitated organization and communication. In small-scale production facilities, this organization is achieved by an employee's—named the foreman—follow-up and analysis of the work performed by the personnel working with the machine. Although the need for personnel increases in this scenario, the relevant employees may be insufficient in the large-scale production line, and the cost rises in case of an increase in the number of employees. For such reasons, an adequate and efficient analysis follow-up cannot be ensured. Many different functions are performed with or by different machines, making it increasingly difficult to control. Moreover, as the costs to be calculated multiply, performing a calculation entirely at the initiative of human beings complicates the situation and increases the error rate. These, in turn, cause great harm to companies. Furthermore, detection of the malfunctions of the machine by the operator is a time-consuming and arduous task.

Due to the developing technology and growing needs, many organizations in both the state and private sector wish to be able to connect with their relevant machines in order to quickly and reliably provide emergency response to central computer systems, get instant reports or eliminate technical deficiencies caused by operators, and obtain required cost analyzes at any time.

Manufacturers need to be able to respond to changing customer demands more quickly and adapt to developments. The flexibility needed for adaptation can only be achieved and ensured by having the relevant software components and an increased level of automation. However, this leads to increasingly complex systems. Disruptions that may occur in the system, including planned maintenance, are troublesome and cause financial losses in the production process.

The German patent no. DE102006025747 in the prior art discloses an automatic system for controlling textile machines, wherein the said system contains a communication network, one or more textile machines, and tools to control the textile machines, one or more display/input unit (HMI-Human Machine Interface), and also wired and/or wireless networking. In this patent, a system has been designed to ensure remote control of a system containing manufacturing machines operating without the need for human labor. Thus, it is believed that the said invention will not be useful in a manufacturing facility operating on the basis of human labor.

The US patent no. US2003060904 in the prior art discloses a system obtaining and reporting data such as machine start time and duration of machine downtime via a data acquisition device in order to determine the optimum operating speed of a production machine.

In conclusion, the requirement for the elimination of shortcomings and disadvantages of embodiments and practices existing in the prior art and already being used as of today entails an improvement in the respective technical field.

### DESCRIPTION OF THE INVENTION

Developed for eliminating the aforementioned disadvantages and providing new advantages to the respective technical field, the present invention relates to a remote machine access, monitoring, and reporting system.

An objective of the present disclosure is to provide technical reports about the cause of machine breakdown and to perform and complete technical support and maintenance processes faster and in a result-oriented manner.

Another objective of the present disclosure is to remotely detect the errors that occur in the machine without physically inspecting the machine on the spot and to reduce the technical service costs.

A further objective of the present disclosure is to ensure that the efficiency of the machine can be monitored daily, weekly, or monthly based on the determined parameters and it is reported accordingly.

A further objective of the present disclosure is to detect problems that the operators may not notice while operating the machine and to reduce the required manpower.

Another objective of the present disclosure is to prevent the financial loss resulting from the technical service costs that arise out of machine breakdowns due to various malfunctions.

Another objective of the present disclosure is to provide a great benefit and convenience by enabling the user to monitor from a single page all the machines that need to be tracked.

A further objective of the present disclosure is to ensure a sharper and error-free manual calculation by multiplying the amount of raw material and consumption.

Another objective of the present disclosure is to ensure that data is stored in its native database even when there is no internet. These stored data are then synchronized with the cloud database when the internet becomes available, preventing the loss of data.

Another objective of the present disclosure is to provide great convenience to the user by the creation of a barcode by the system at the end of work orders and the attachment of it onto the finished product and by the direction of the user to the relevant report page showing information as to the production details of the said product, the work order details, and the cost of its production when the said barcode is scanned.

Instant data can be obtained from the labels and the data about any applied change can be transferred to the labels instantly. Labels are placed on the front of the products and matched with the required codes in the host. Thus, remote control management of the labels matching the product codes is ensured by way of the label management control system using the price list in the host machine.

A further objective of the present disclosure is to provide easy access to the machines of their organizations for the bosses on business travel. Many organizations are concerned about the use of the default machine clock, whether it is working efficiently, or whether there are any technical malfunctions. Thanks to the invention, this uneasiness will be prevented by way of instant data access.

Another objective of the invention is to provide many advantages thanks to less configuration effort, customized system management, status monitoring, and status reporting, facility access features, as well as secure remote maintenance and remote diagnosis solution.

Another objective of the invention is to monitor, with the help of audio and image projection technologies, the data received from the machines.

A further objective of the invention is to provide information about planned/unplanned machine stoppages via the display and audio systems through the application.

Another objective of the invention is to ensure that the machine maintenance times are reminded in advance by creating a predictive maintenance plan, thus allowing the tracking of the said plan easily and preventing the missing of any time due to human error.

A further objective of the invention is to enable the simultaneous performance of both the automatic reporting system to be adjusted as desired and the work order-based reporting and barcode function.

A further objective of the invention is to ensure that it adapts to and therefore can be implemented in any desired machine.

### DRAWINGS

The embodiments of the present invention, briefly summarized above and discussed in more detail below, can be understood by referring to the exemplary embodiments of the invention described in the accompanying drawings. However, it should be noted that the accompanying drawings illustrate only the typical embodiments of the present invention and therefore are not deemed to limit its scope as it may allow other equally effective applications.

For the sake of clarity, identical reference numbers are used wherever possible, to indicate identical elements common to the figures. The figures are not drawn to scale and can be simplified for clarity. It is contemplated that the elements and features of an application can be usefully incorporated into other applications without the need for further explanation.

FIG. 1: Client Connection Control Algorithm of the Invention

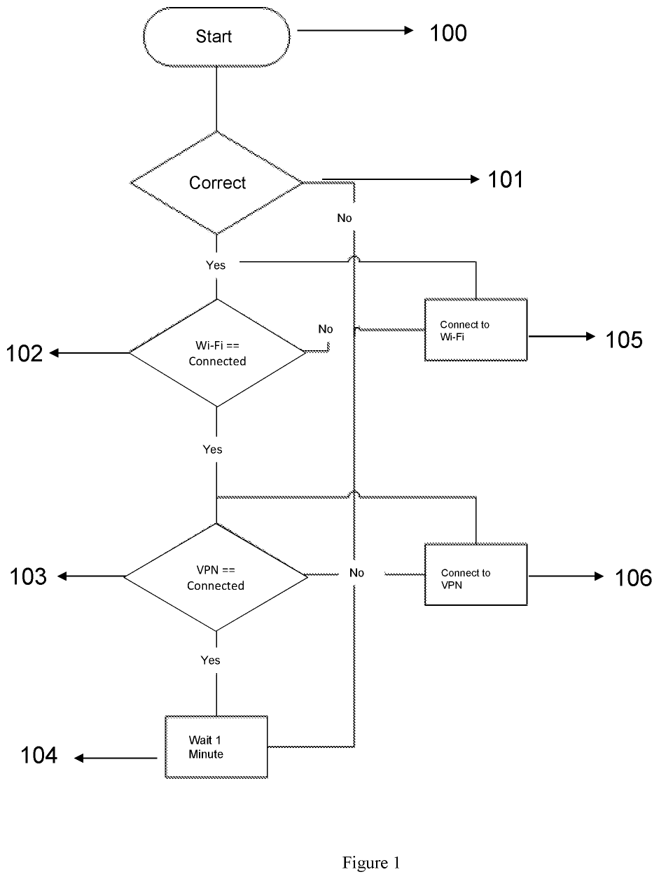

FIG. 2: Machine Data Collection Algorithm of the Invention

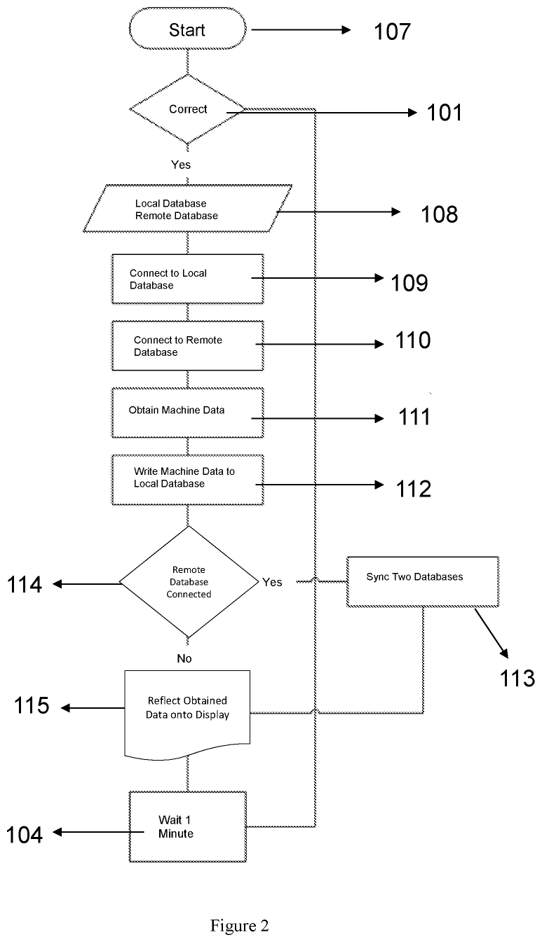

FIG. 3: Remote Access and Update Algorithm of the Invention

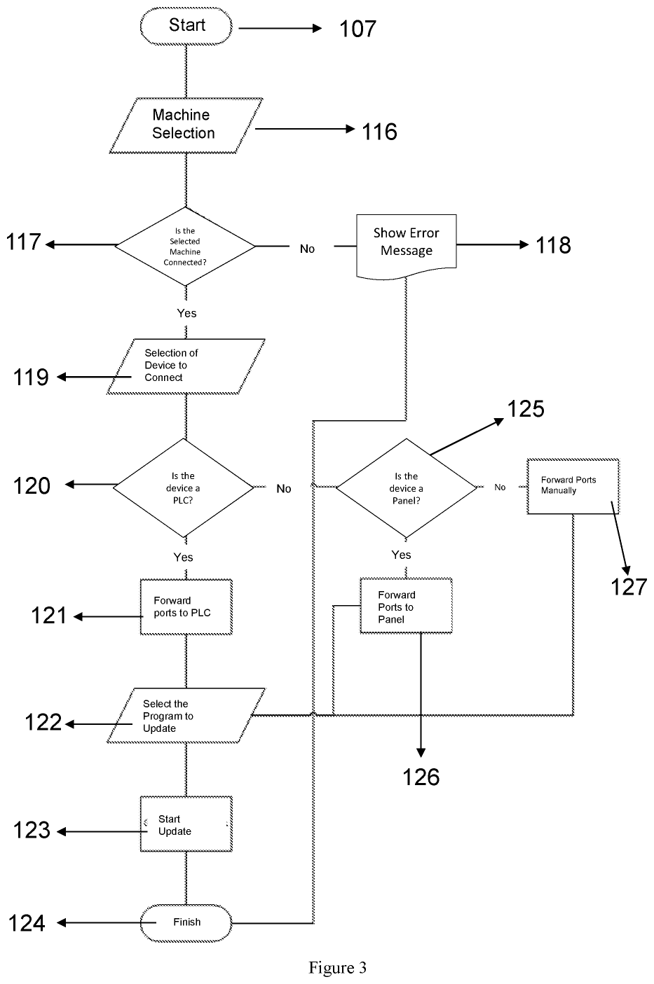

FIG. 4: Data Display Algorithm from User Interface

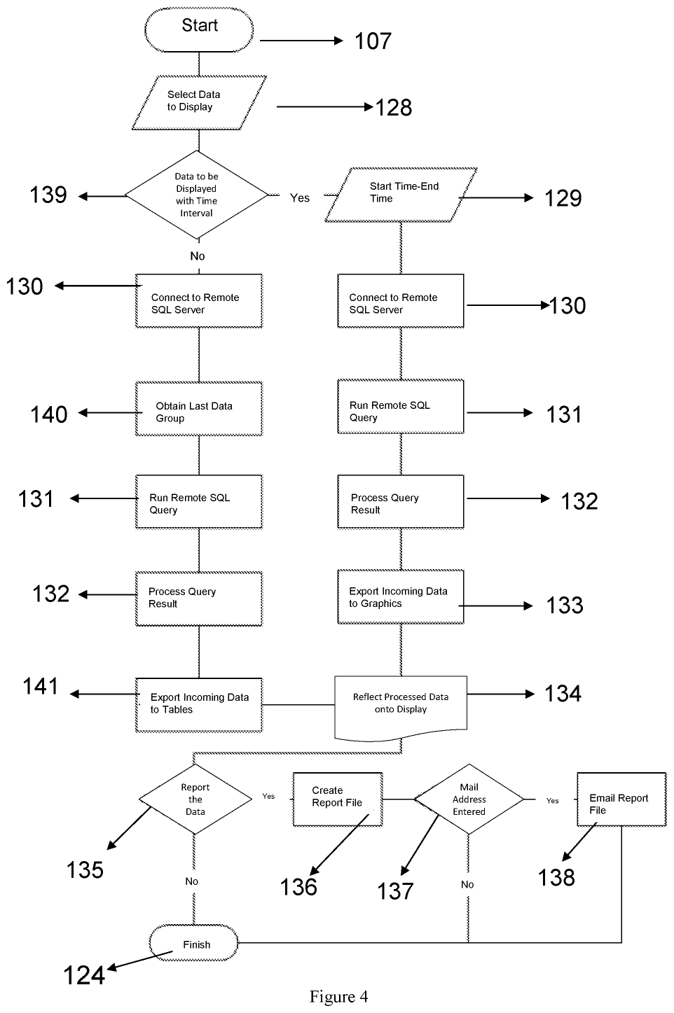

FIG. 5: It is the schematic view of the system of the invention.

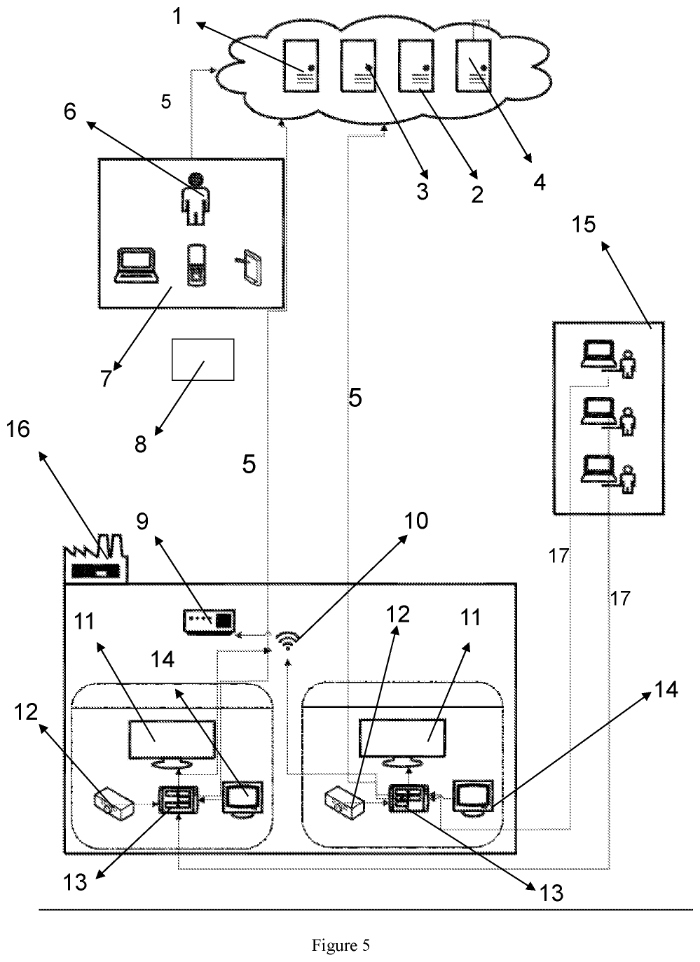

### EXPLANATION OF THE DETAILS IN THE DRAWINGS

Explanations of reference numbers shown in the drawings are given below.
1—CRM Database Server
2—Application Server
3—Machine Server
4—VPN Server
5—Internet
6—User
7—Electronic Device
8—Mobile Application
9—Modem
10—Wi-Fi
11—Machine Display
12—PLC
13—Mini Computer
14—Industrial Panel
15—Support Team
16—Factory
17—VPN Connection
   100—Start
   101—Correct
   102—Wi-Fi==Connected
   103—VPN==Connected
   104—Wait 1 Minute
   105—Connect to Wi-Fi
   106—Connect to VPN
   107—Start
   108—Local Database—Remote Database
   109—Connect to Local Database
   110—Connect to Remote Database
   111—Obtain Machine Data
   112—Write Machine Data to Local Database
   113—Sync Two Databases
   114—Remote Database Connected
   115—Reflect Obtained Data onto Display
   116—Machine Selection
   117—Is the Selected Machine Connected?
   118—Show Error Message
   119—Selection of Device to Connect
   120—Is the device a PLC?
   121—Forward ports to PLC
   122—Select the Program to Update
   123—Start Update
   124—Finish
   125—Is the device a Panel?
   126—Forward Ports to Panel
   127—Forward Ports Manually
   128—Select Data to Display
   129—Start Time-End Time
   130—Connect to Remote SQL Server
   131—Run Remote SQL Query
   132—Request Query Server
   133—Export Incoming Data to Graphics
   134—Reflect Processed Data onto Display
   135—Report the Data
   136—Create Report File
   137—Mail Address Received
   138—Email Report File
   139—Data to be Displayed with Time Interval
   140—Obtain Last Data Set
   141—Export Incoming Data to Tables

### DETAILED EXPLANATION OF THE INVENTION

The preferred alternatives of the embodiment of the present disclosure, which are mentioned in this detailed description, are only intended for providing a better understanding of the subject matter, and should not be construed in any restrictive sense.

The invention is characterized in that it is a system that creates cost sheets presenting a total cost analysis by multiplying the values and unit costs entered to the machine, can store all data in case of no internet (5) connection thanks to its native database, allows monitoring the data received from the machines with the help of audio and image projection technologies, enables providing information about planned/unplanned machine stoppages via the display and audio systems through the application, reminds the machine maintenance times in advance by creating a predictive maintenance plan, contains an automatic reporting system, ensures the communication of generated reports to the user (6) via e-mail, and has properties including work order-based reporting and barcode creation.

The invention is characterized in that it consists of:
at least one database storing information about the raw materials and their weight in grams entered to the machine,
at least one barcode system to create individual barcodes for each product and to attach it onto the relevant product once the work order report is recorded in the system upon the completion of work orders,
at least one cloud system storing all mentioned information through the internet (5),
at least one interface allowing the users (6) to log in and create an account for themselves in the system,
at least one electronic device (7) that allows the user (6) to display all data and in which the reporting takes place,
at least one machine display (11) enabling the instant monitoring of converted data,
at least one mobile application (8) providing an opportunity to track all data via a single platform,
at least one mini computer (13) collecting and processing data received from the machine, and transferring such to servers,
at least one industrial panel (14) required to determine the data to be collected and to allow the machine operator to enter set values,
at least one PLC (12) through which the machine is managed, and which ensures collection of needed data,
at least one Wi-Fi (10) enabling the connection of mini computer (13) to the internet,
at least one machine server system (3) where machine data will be kept,
at least one VPN server (4) ensuring the connection between devices,
at least one CRM database server (1) keeping CRM data of the application,
at least one application server (2) to run the application since the application is web-based,
at least one modem (9) ensuring the connection between the computers and the general network and connecting a computer to other computers in remote locations,
at least one user (6) enabling the remote monitoring of the system, and
internet (5) ensuring the connection of the user to the cloud system.

### a) Remote Monitoring of Machine Status

Under normal conditions, the machine owner must contact the machine operator or check the performed operations from the machine panel in order to learn if the machine at the factory (16) works or which operation it performs. Thanks to the present invention, s/he can display, on a single page, the said information for all of his/her machines via a web browser on the computer or via an application on a mobile device, wherever s/he wishes.

### b) Cost Calculation

Cost calculation is easy either at the end of production or instantly, thanks to the calculation of how much of which raw material is used.

c) Reporting of the Times and Reasons of Decreased Efficiency of the Machine with Time Reports

Thanks to the databases with back-up, machine efficiency is increased by reporting the times when the efficiency of the machine decreases or when the machine is turned on and off, by including the relevant reasons.

### d) Remote Machine Access

With the help of a set-up VPN network, the invention helps to connect directly to the machines and to quickly detect technical problems or solve the emerging software problems. In cases where there is no VPN connection (17), it is possible to set up a connection via static IP or dynamic DNS.

### e) CRM Integration

The database of the software is integrated into the CRM system that the user (6) already utilizes, enabling easy management of raw material costs and stock information.

### f) Work Order and Finished Product Tracking

The system creates a barcode at the end of work orders and records the work order report in the system. The said barcode is attached onto the finished product. When the barcode is scanned, the user is directed to the relevant report page showing information as to the production details of the said product, the work order details, and the cost of its production.

### g) Time Reports

Retrieval of machine-based daily, weekly, or monthly reports is set from the user (6) panel.

A report is created at the specified times and sent to the user (6) via e-mail.

The application method of the invention is as follows:
1) Connecting of the mini computer (13) where the software is installed to the machine to be connected to the system;
2) Adding of the mini computer (13), via the internet (5), to the (VPN) network either quickly via the barcode system or manually;
3) Checking, by the mini computer (13), of the connection with the controller software every minute after its installed software connects to the system, converting of the data received from the machine (PLC (12), Panel or machine operating system) into a readable form and starting of the storing of the machine data, recording of such into the software's native database if the Internet connection is lost, and synchronizing of the local and cloud database when the Internet connection is restored;
4) Providing of user (6) name and password to the user (6), i.e. the owner of the machine, to enable logging in to the system;
5) Directing of the user (6) to the password creation page to allow him/her to set his/her own password if s/he is logging in for the first time, and then introducing of the system with the system tutorial;
6) Monitoring, instantly by the user (6), of the status of the relevant machine and being able to intervene if necessary, after completion of the above-mentioned steps;
7) Calculating of the cost of the product produced by the machine if the user (6) has entered the raw material costs through the system;
8) Having the opportunity, for the user (6), to see the historical data or create reports by specifying the time interval since the machine data is saved in the database on a minute-by-minute basis;
9) Sending of the generated reports or data to an e-mail address designated by the user (6).
1—Connection control of the machine is performed as explained below:
   The software in the mini computer (13) constantly monitors the connection.
   It connects to the Wi-Fi (10) network selected by the machine operator from the panel.
   It connects to the VPN network after internet access is ensured.
   It constantly checks this status every minute.
2—Retrieval and processing of data from the machine are carried out as described hereinbelow:
   The mini-computer (13) accesses the machine data thanks to its software.
   It processes this information and makes them readable.
   If there is internet (5), it writes the information to the cloud system and its native database.
   If there is no internet, it only stores the information in its native database.
   It synchronizes the cloud and its native database when the internet becomes available again.
   At the end of these steps, it reflects the output data onto the machine screen (11).
   It performs this procedure every minute.
3—The user (6) displays data from the system as follows:
   The login information created for the user (6) is given.
   The user (6) is directed to the password creation screen if s/he is logging in for the first time.
   The user (6) logs in again after setting his/her password.
   S/he selects the data s/he wants to display from the menu on the right.
   Under the Overview menu, whether all machines are active or not and the total efficiency of all machines are displayed.
   Under the My Displays menu, the user (6) can see all of the screens connected to the machines on the same page.
   Under the Live Data menu, the user (6) can see the instant statistics of the machine and the costs per kilogram.
   Under the Reports menu, the user (6) can create instant or time interval reports and store them. If s/he wishes, s/he can send these reports via his/her e-mail address.
   Under the Raw Material Costs menu, the user (6) can see the raw materials used by the machines. S/he can enter the raw material costs for the machine of his/her choice or the machine that uses the same raw material. The cost is recorded in different currencies and different currencies are shown individually in the reports if any.
   For example: Procedures can be carried out in different currencies as in this example: the cost of 1 KG of product=1.2 [symbol] +0.3$. [symbol]
4—Remote access and update procedures are performed as described hereinbelow:
   The technical support person selects the machine to be connected.
   If the machine is connected, the device to be connected is selected.
   The ports to be used are routed to the device.
   Necessary updates and corrections are performed.

1- A system allowing remote access, monitoring, and reporting, wherein the said system enables the monitoring of machines connected to the system via an internet connection, the calculating of instant costs per production/work order, and the daily, weekly, or monthly monitoring and reporting of the concerned machine's efficiency based on these operation and cost parameters, in addition to enabling the performing of general updates through remote intervention in case of any malfunction in the machine, characterized in that it consists of:
at least one database storing information about the raw materials and their weight in grams entered to the machine,
at least one barcode system to create individual barcodes for each product and attach it onto the relevant product once the work order report is recorded in the system upon the completion of work orders,
at least one cloud system storing all mentioned information through the internet (5),
at least one interface allowing the users (6) to log in and create an account for themselves in the system,
at least one electronic device (7) that allows the user (6) to display all data and in which the reporting takes place,
at least one machine display (11) enabling the instant monitoring of converted data,
at least one mobile application (8) providing an opportunity to track all data via a single platform,
at least one mini computer (13) collecting and processing data received from the machine, and transferring such to servers,
at least one industrial panel (14) required to determine the data to be collected and to allow the machine operator to enter set values,
at least one PLC (12) through which the machine is managed, and which ensures collection of needed data,
at least one Wi-Fi (10) enabling the connection of mini computer (13) to the internet,
at least one machine server system (3) where machine data will be kept,
at least one VPN server (4) ensuring the connection between devices,
at least one CRM database server (1) keeping CRM data of the application,
at least one application server (2) to run the application since the application is web-based,
at least one modem (9) ensuring the connection between the computers and the general network and connecting a computer to other computers in remote locations,
at least one user (6) enabling remote monitoring of the system, and
internet (5) ensuring the connection of the user to the cloud system.

2- A method allowing remote access, monitoring, and reporting, wherein the said system enables the monitoring of machines connected to the system via an internet connection, the calculating of instant costs per production/work order, and the daily, weekly, or monthly monitoring and reporting of the concerned machine's efficiency based on these operation and cost parameters, in addition to enabling the performing of general updates through remote intervention in case of any malfunction in the machine, characterized in that it consists of the following steps:
Connecting of the mini computer (13) where the software is installed to the machine to be connected to the system;
Adding of the mini computer (13), via the internet (5), to the (VPN) network either quickly via the barcode system or manually;
Checking, by the mini computer (13), of the connection with the controller software every minute after its installed software connects to the system, converting of the data received from the machine (PLC (12), Panel or machine operating system) into a readable form and starting of the storing of the machine data, recording of such into the software's native database if the Internet connection is lost, and synchronizing of the local and cloud database when the Internet connection is restored;
Providing of user (6) name and password to the user (6), i.e. the owner of the machine, to enable logging in to the system;
Directing of the user (6) to the password creation page to allow him/her to set of his/her own password if s/he is logging in for the first time, and then introducing of the system with the system tutorial;
Monitoring, instantly by the user (6), of the status of the relevant machine and being able to intervene if necessary, after completion of the above-mentioned steps;
Calculating of the cost of the product produced by the machine if the user (6) has entered the raw material costs through the system;
Having the opportunity, for the user (6), to see the historical data or create reports by specifying the time interval since the machine data is saved in the database on a minute-by-minute basis;
Sending of the generated reports or data to an e-mail address designated by the user (6).
